(19) United States
(12) Patent Application Publication
(10) Pub. No.: US 2017/0241782 A1
(43) Pub. Date: Aug. 24, 2017

(54) Collated Molded Plastic Markers

(71) Applicant: FlagShooter Holdings, LLC, Garretson, SD (US)

(72) Inventor: Paul M. Carrette, Garretson, SD (US)

(73) Assignee: FlagShooter Holdings, LLC, Garretson, SD (US)

(21) Appl. No.: 15/431,515

(22) Filed: Feb. 13, 2017

Related U.S. Application Data
(60) Provisional application No. 62/298,185, filed on Feb. 22, 2016.

(51) Int. Cl. G01C 15/04; G09F 3/00

(52) U.S. Cl. CPC G01C 15/04; G09F 3/00

(57) ABSTRACT

A set of collated plastic markers. The markers have a small cross-section relative to conventional plastic markers, yet are easily insertable into the ground manually or with a marker installer and stiff enough to stand up as an indicator. Each marker comprises a shaft and a flag. The shaft comprises an insertion portion, a mast, and an engagement portion. The insertion portion is substantially wedge shaped and the engagement portion is configured to provide a push surface for manual insertion or to cooperate with a marker installer. The shafts are collated before or after flags are attached and held together in a spaced-apart arrangement with one or more connectors. Preferably a set of collated shafts is molded of plastic, the shafts attached to each other with connectors that can be pulled apart by hand or sheared off with a maker installer to separate the markers from one another during installation.

### CROSS-REFERENCE TO RELATED APPLICATIONS

This application claims the benefit of co-pending U.S. Provisional Application No. 62/298,185 filed Feb. 22, 2016.

### FIELD OF INVENTION

This invention relates generally to ground marking systems, and more particularly to a set of plastic markers for manual insertion or with a marker installer.

### BACKGROUND

It can be desirable to mark the ground surface to indicate, for example, the presence of underground utilities, the location of lot boundaries and the like. Sometimes the ground is marked with spray paint, the paint lines indicating the approximate location of the boundary, underground pipes, wires, or cables. Sometimes markers are inserted into the ground that extend upward from the ground surface and may include a flag at the top end. Numerous markers may be placed at spaced locations along the boundary or path of the buried utility line, and different markers may be used for each utility service, such as electric, gas, telephone, water, or sewer.

Conventionally each marker is inserted into the ground by hand by grasping a single marker from a holster or handful of flags, bending over and pushing the marker into the ground. This method is repeated until a desired length of the boundary or buried cable has been marked. This method of marker installation carries a variety of deficiencies. The process is laborious due to the numbers of markers that need to be placed as well as the manner in which the markers are inserted. Repeatedly bending over is physically taxing on the person performing the marking operation. Compacted, stony, and even slightly frozen terrain makes the insertion more difficult.

Installation of markers into the ground is made even more difficult if the marker is not the right stiffness: if the marker is too flimsy it won't penetrate the ground or stand up straight enough to serve as an indicator. A disadvantage of conventional plastic markers is that to get them stiff enough to be readily inserted into the ground, the mast has to be have a much larger cross-section than a metal-masted marker. But a thicker marker is more difficult to insert into the ground because there's more friction against the larger surface area. Thus, it would be desirable to have a plastic-masted marker than was sufficiently stiff to be inserted into the ground, while being sufficiently slender to have little resistance to insertion. It would also be desirable to have a group of markers that are easy to carry together.

### SUMMARY OF THE INVENTION

The present invention is a set of collated plastic markers. The markers have a small cross-section relative to conventional plastic markers, yet are easily insertable into the ground manually or with a marker installer and stiff enough to stand up as an indicator. Each marker comprises a shaft and a flag. The shaft comprises an insertion portion, a mast, and an engagement portion. The insertion portion is substantially wedge shaped and the engagement portion is configured to provide a push surface for manual insertion or to cooperate with a marker installer. The shafts are collated before or after flags are attached and held together in a spaced-apart arrangement with one or more connectors. Preferably a set of collated shafts is molded of plastic, the shafts attached to each other with connectors that can be pulled apart by hand or sheared off with a maker installer to separate the markers from one another during installation.

### BRIEF DESCRIPTION OF THE DRAWINGS

FIG. 1 is a side view of a marker according to the present disclosure that has been inserted into the ground.

FIG. 2A is a front view of a set of collated markers without flags.

FIG. 2B is a rear view of a set of collated markers without flags.

FIG. 2C is a side view of a set of collated markers without flags.

FIG. 3 is a top view of a set of collated markers without flags.

FIG. 4 is a close-up view of the portion of FIG. 2A in the dotted-line square.

FIG. 5 is a side view of a set of collated markers without a label surface.

FIG. 6 is a partial side view of a middle section of the engagement portion of a marker.

### DETAILED DESCRIPTION OF THE INVENTION

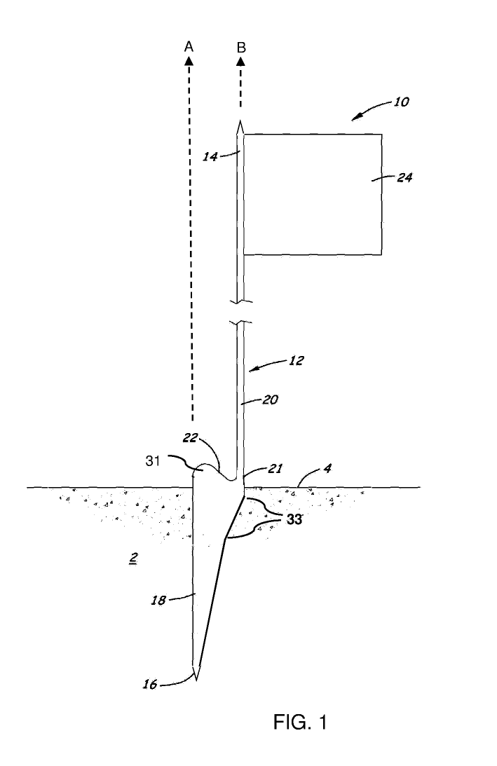

FIG. 1 illustrates a marker 10 of the present invention inserted into the ground 2. Each marker comprises a shaft 12 and a flag or other visual indicator such as a ball or placard, referred to herein as a flag 24.

The shaft 12 has a top end 14 and a bottom end 16. The shaft 12 has a length that may be measured between the top 14 and bottom 16 ends. The shaft 12 of the marker 10 may be conceptually divided into a number of portions that have different purposes or functions. The shaft comprises an insertion portion 18, a mast portion 20, and an engagement portion 22.

The mast portion 20 extends above the ground surface 4 when the insertion portion 18 is at least partially inserted into the ground 2. The mast portion 20 is preferably substantially straight and extends along an axis B. Axis B of the mast portion 20 may be oriented substantially parallel to axis A of the insertion portion 18. Axis B of the mast portion 20 is preferably, but not necessarily, laterally offset by a distance x from axis A. The offset of axis A from axis B may be in the range of approximately 0.1 inch to approximately 1.0 inch, and is preferably about 0.5 inches although other offsets may be employed. In one embodiment mast portion 20 has a substantially uniform cross-sectional shape along the length of the shaft, preferably square or rectangular, although it could be circular, hexagonal, star-shaped, triangular, oval, trapezoidal, or other shape. The cross-sectional dimension of the mast ranges from about 0.09-0.3 inch depending on the desired stiffness of the mast. Preferably the cross section of the mast is square, with a cross-sectional dimension of about 0.09-0.1 inch and more preferably about 0.095 inch. The mast is long enough to be easily seen above the surrounding foliage, snow or other ground cover, typically 10-36 inches long, measured from the top most point to the lower extremity. In a preferred embodiment the mast is about 24 inches long. The mast can be made in any color for indicating what type of line is buried underground or for branding.

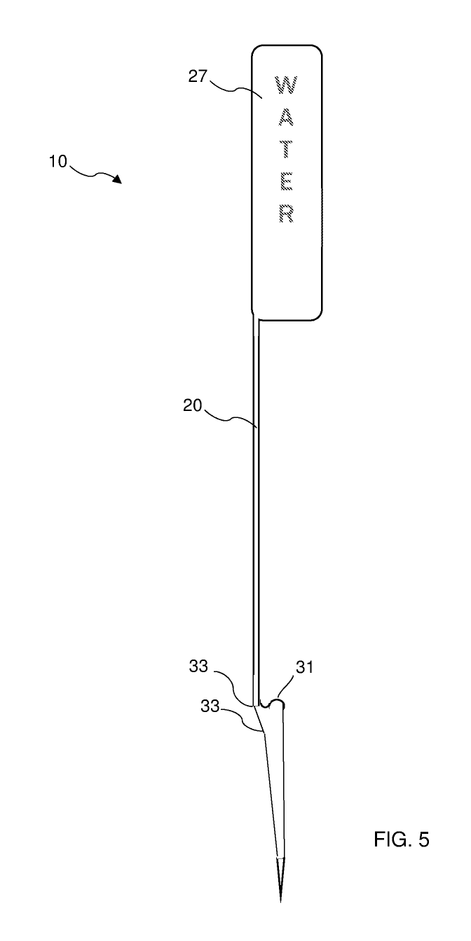

In another embodiment, mast portion 20 has a non-uniform cross-sectional shape. For example, the top portion of the marker may be much be much larger in cross-section than the lower portion. This may be particularly advantageous for creating a label surface to accommodate letters or symbols printed thereon to be readable from a distance. FIG. 5 is an example of a marker the word WATER printed on a rectangular label surface 27, used to indicate where an underground water pipe is. The label surface can be any shape, including rectangular, square, circular, hexagonal, star-shaped, triangular, oval, trapezoidal, or other shape. Any word or symbol can be printed on a label surface 27, or a sticker applied thereto.

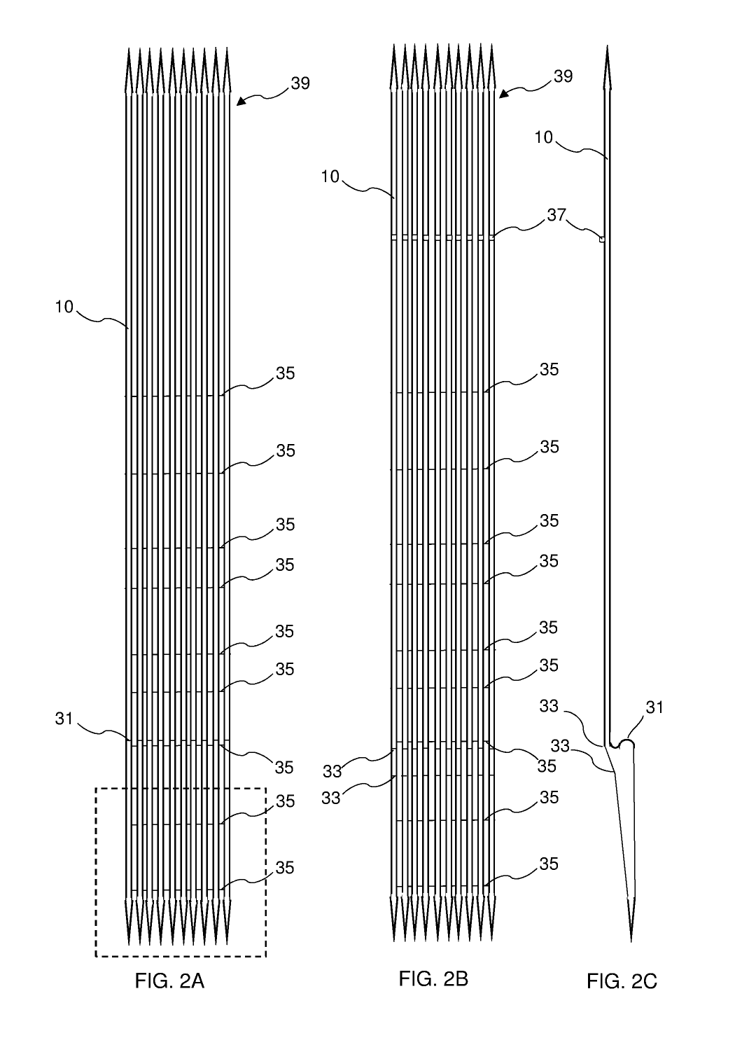

The lower extremity 21 of the mast 20 is connected to the insertion portion 18. The insertion portion 18 is the portion of the marker 10 that is inserted into the ground 2 through the surface 4 of the ground. The insertion portion 18 is located toward the bottom end 16 of the shaft 12, and may be adjacent to the bottom end 16. The insertion portion 18 is preferably substantially wedge shaped, with shoulder 31 and bends 33, as shown in FIGS. 1 and 2C. This wedge shape provides structural integrity to insertion portion 18 so that it doesn't bend so much that it becomes noodle-like, unable to be forced into the ground. The long edge of the wedge is substantially parallel to a mast portion 20, extending along an axis A. The insertion portion 18 typically has a rectangular cross-sectional shape that decreases in area from the shoulder area to the bottom end 16 to form a point. Generally the insertion portion 18 is about 1.0-12.0 inches long, measured from the shoulder to the bottom at the tip. In a preferred embodiment the insertion portion is about 3.95 inches long. Other cross sectional shapes of the insertion portion 18 may be employed, including circular, hexagonal, star-shaped, triangular, oval, trapezoidal, or other shape. The insertion portion 18 can be made in any color and typically is the same color as the mast portion 20.

The length of the insertion, engagement, and mast portions may vary. In some embodiments, the length of the insertion portion 18 is less than approximately 40% of an overall length of the marker 10 as measured from the bottom end 16 to the top end 14 (as contrasted with the actual length of the shaft between the top and bottom ends), and may be less than approximately 25% of the overall length. In one embodiment, the length of the insertion portion 18 is a minimum of approximately 5% of the overall length of the marker 10, and in some embodiments may be approximately 25% of the overall length. In one embodiment, the length of the insertion portion 18 is approximately 3 inches and the overall length of the marker 10 is approximately 24 to approximately 30 inches.

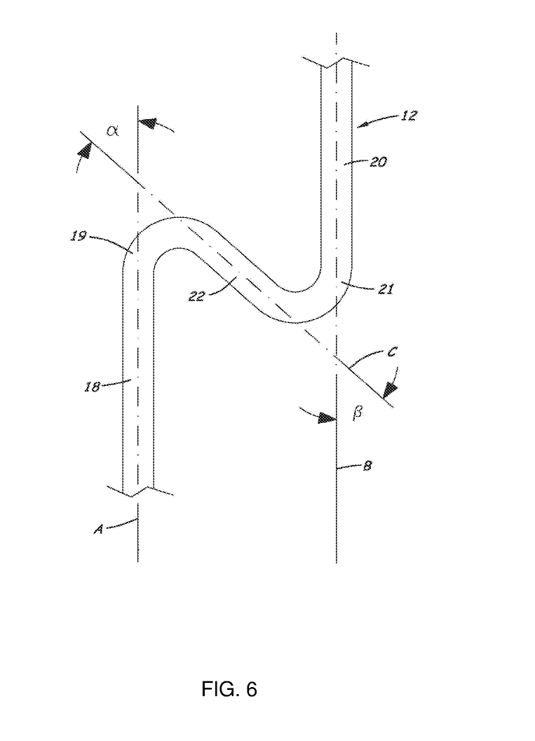

The shaft 12 also includes an engagement portion 22 that functions as a push surface for manual insertion or that cooperates with a marker installer, or both, to enable the marker to be driven into the ground. Marker installers that cooperate with engagement portions include those similar to those disclosed in U.S. Pat. No. 8,656,857, which is incorporated herein by reference. Marker installers are commercially available from FlagShooter, Inc. The engagement portion 22 is located between the insertion portion 18 and the mast portion 20 of the shaft 12. The engagement portion 22 may connect the mast portion 20 to the insertion portion 18, and thus may extend between the shoulder 31 of the engagement portion and the lower extremity 21 of the mast portion. Utilization of the engagement portion 22 may avoid relying solely upon friction when inserting the marker into the ground. The engagement portion 22 may extend along an axis C. See FIG. 6. The axis C of the engagement portion 22 may be oriented at a non-zero angle α to the axis A of the insertion portion 18. Although it is contemplated that angles α measuring greater than zero degrees and less than or equal to approximately 135 degrees may be utilized, it is believed that angles α measuring at or between approximately 5 degrees and approximately 95 degrees with respect to the axis A of the insertion portion are the most effective for the purpose of providing a positive engagement with the shaft for insertion of the shaft 12 into the ground surface. In some embodiments, the angle α may be in the range of approximately 30 degrees and approximately 60 degrees. In still other embodiments, the angle α may be in the range of approximately 40 degrees and approximately 50 degrees. The values of angle β may be substantially the same as the values for angle α, although identical values are not required.

The width of the engagement portion 22 may be a function of the offset between the axes of the insertion 18 and mast 20 portions so that the greater the offset, the larger the size of the engagement portion and the smaller the offset, the smaller the size of the engagement portion. The engagement portion 22 typically has cross-sectional shape is the same as that of the insertion portion which, if rectangular, increases in area from the shoulder 31 to the point at which it connects to the insertion portion 18. In some embodiments the engagement portion 22 can have a different cross-sectional shape than the insertion portion 18, such as a more oval cross-sectional shape.

Although the insertion 18, mast 20, label surface 27, and engagement 22 portions may be angled or offset from each other in different reference planes, it should be appreciated that the insertion 18, mast 20, label surface 27, and engagement 22 portions of the shaft 12 may lie in a common plane.

The top end 14 of the marker can be shaped to facilitate the attachment of hemmed flags to the shaft 12 by sliding them over the top end 14 of the marker. For example the top end 14 can be rounded, flat, blunt or, preferably, gets smaller and tapered nearer the end. In some cases the shaft 12 has a cap or head on it that has a cross-section larger than the cross-section of the mast, much like a nail head, although the larger the head has some disadvantages. For example, with a larger head it is more difficult to slip a flag on the mast over the top end, the distance must be greater between collated markers, and fewer markers can be in a set of a given width. A shaft 12 also preferably includes a nub 37 on one side of the marker 10 for retaining a hemmed flag on the marker. In a preferred embodiment, each shaft 12 has a first side, a front side, a second side, and a rear side, and the nub 37 is preferably attached to the front or the rear side, as shown in FIG. 2C. Attaching the nub to the first or second side may increase the space needed between the markers. If the flag 24 is instead glued, welded, or otherwise attached directly to the shaft, the top end 14 may be blunt instead of rounded or tapered and the nub 37 may not be needed. The bottom end 16 of the shaft is preferably sharply tapered to facilitate insertion into the ground.

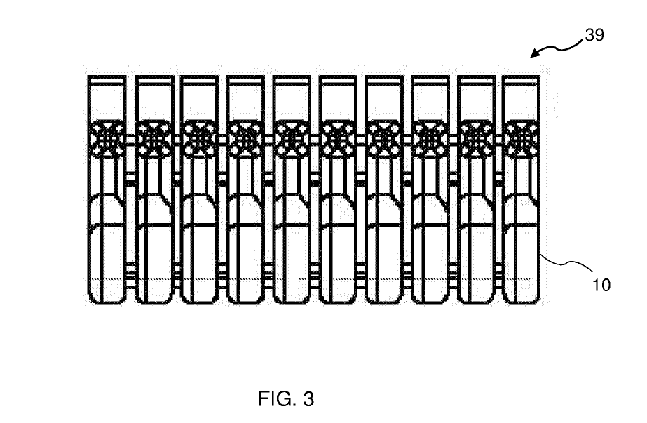

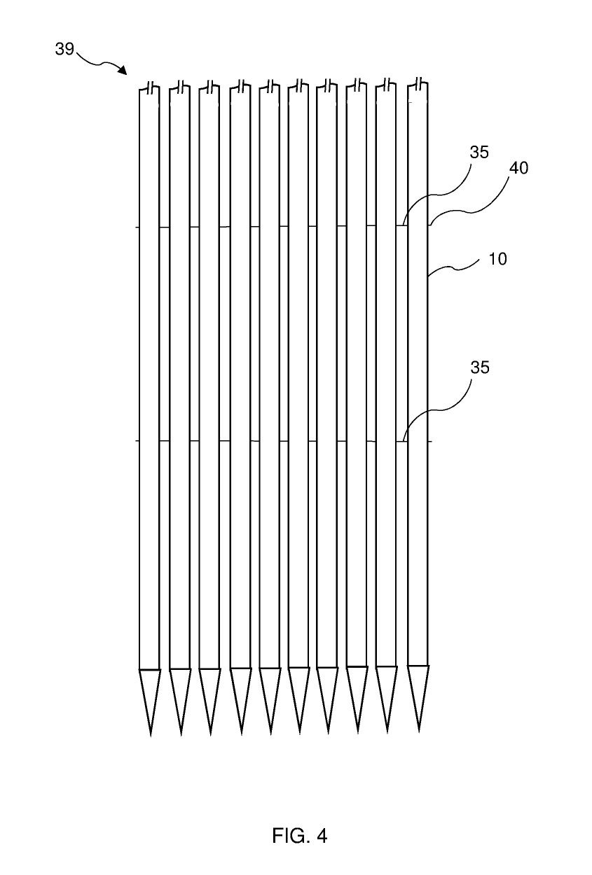

The markers are preferably collated into a set 39. FIGS. 2A and B show the front and rear views, respectively, of a set 39 of ten markers 10 that have been collated and attached together by means of several connectors 35. For clarity the markers are shown without flags. FIG. 3 shows a top view of a set 39. A connector 35 is a slender tube or thread that runs between each pair of shafts, connecting one to the next. The connector 35 is so slender that it is relatively easily pulled apart by hand or sheared off by a marker installer, so that the markers 10 can be separated from one another for installation. The cross-sectional dimension of the connector ranges from about 0.004-0.04 inches (0.1 mm to 1.0 mm) depending on the amount of shear stress desired for separation. For connectors that have a circular cross-section, the cross-sectional dimension is also called a diameter; for connectors that have a more rectangular cross-section, that dimension may be called a width. Preferably the cross-section of a connector is about 0.025 inch (0.635 mm), whether a diameter or a width. In a preferred embodiment with a rectangular cross section, the cross-section in a first dimension is 0.007 inches thick (the width) and 0.018 inches deep (front to back). The connector can be integral with the markers, connected to the sides of the shafts between the markers, or pass through each marker such that the connector doesn't wrap around the surface of the marker on the front or rear. Typically the connector is plastic but may be made of other material that can be pulled apart or sheared, such as metal, paper, fibrous thread, or bristle.

One or more connectors can be used. In one embodiment, the connectors 35 bridge the nine gaps between each of the ten markers, spaced along the shaft 12 at various points indicated in FIGS. 2A and B. In this embodiment the connectors are located only on about the bottom two-thirds of the set 39, to facilitate expulsion from a marker installer. For clarity, the bends 33 in the wedge-shaped insertion portion 18 and the shoulder 31 are indicated in FIGS. 2A and B in addition to the connectors 35.

Preferably all connectors 35 in a set 39 are uniform so that the force necessary to separate the markers at each connector is the same. However, in some embodiments it may be desirable to have a connector with a thicker or thinner cross-section than the others in the set. In some embodiments it may be desirable to have a connector with a different cross-sectional shape than the others in the set.

Preferably a set of collated shafts is molded of plastic and the shafts are attached to each other with plastic connectors that can be pulled apart by hand or sheared off with a marker installer to separate the markers from one another during installation. Plastic has the advantage of not rusting. Preferably the set 39 is made by molding plastic using an injection mold, so that the connectors are integral with the markers and the markers are substantially uniform. (Note that extrusion molding, the method used to make plastic markers of the prior art, is incapable of creating a set with connectors and generates relatively inconsistent uniformity from marker to marker.) It may be advantageous to mold more shafts at one time than would typically be in a set. For example, it may be advantageous to mold one hundred shafts or more at a time in a single mold, all connected together, before they are divided into smaller sets of ten or 20. Once divided into sets, one or more vestigial free-ends 40 of the connectors may remain. Alternatively shafts may be collated by other means including adhesive, sonic welding, or plastic or paper tape. The shafts may be collated before or after flags are attached.

The shafts are preferably solid plastic, but may be plastic with non-plastic components such as air pockets, metals, wood or paper that are integrated into the plastic. Plastic, as used herein, encompasses plastic material of any kind with or without non-plastic components. In a preferred embodiment, the shaft 12 is made of a thermoplastic polymer such as polypropylene. In an alternative embodiment the shaft is made of a biodegradable material.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the attached claims and their equivalents.

1. An article of manufacture comprising:
a. a first marker and a second marker; and
b. a connector that connects the first marker to the second marker, wherein the connector is capable of being pulled apart from the first or second marker by hand or is shearable by a marker installer.

2. The article of claim 1 wherein the first marker, second marker, and connector are made of the same plastic as the markers.

3. The article of claim 2 wherein the connector is integral with the markers.

4. The article of claim 2 wherein the connector is attached to the markers when forming the article from plastic in an injection mold.

5. The article of claim 1 further comprising a third marker, wherein each marker has a first side, a front side, a second side and a rear side and:
a. the connector attaches the first side of the first marker to the second side of the second marker;
b. a second shearable connector attaches the first side of the second marker to the second side of the third marker; and
c. the connector does not cross the front side or rear side of the second marker.

6. The article of claim 1 wherein each marker has a top end and a bottom end and is tapered at both ends.

7. The article of claim 1 further comprising a nub on each marker for retaining a flag.

8. The article of claim 1 further comprising a flag on each marker.

9. An article of manufacture comprising:
a. a first marker, a plurality of middle markers, and a last marker, wherein each marker has a first side, a front side, a second side and a rear side and wherein each middle marker is attached to the markers on either side of it with at least one connector.

10. The article of claim 9 wherein no connector crosses the front side or rear side of the middle markers.

11. The article of claim 9 wherein:
a. each marker is spaced apart from one another by an equal distance in a side-by-side arrangement; and
b. each marker is parallel to the other.

12. The article of claim 9 wherein the connector is capable of being pulled apart from the first, middle or last marker by hand or is shearable by a marker installer to enable the markers to be separated from one another during installation.

13. An article of manufacture for use with a marker installer comprising:
a. a set of plastic markers comprising a first marker, a plurality of middle markers, and a last marker, wherein:
i. each marker has a top end and a bottom end; and
ii. each marker has a mast, an insertion portion, and an engagement portion;
iii. each plastic marker is spaced apart from one another by an equal distance in a side-by-side arrangement; and
iv. each plastic marker is parallel to the other; and
b. a plurality of plastic connectors, each of which attaches each middle marker to the markers on either side of it, wherein the plurality of plastic connectors are in a spaced-apart arrangement from the top end to the bottom end.

14. The article of claim 13 wherein the markers and connectors are formed simultaneously in an injection mold.

15. The article of claim 13 wherein the markers and connectors are formed of polypropylene.

16. The article of claim 13 wherein the markers are identical to each other.

17. The article of claim 13 wherein each marker is 0.09-0.3 inch in cross-section.

18. The article of claim 13 wherein each connector is less than 0.025 inch in cross-section.

19. The article of claim 13 further comprising a nub on each marker for retaining a flag.

20. The article of claim 13 further comprising a flag on each marker.
